(19) United States
(12) Patent Application Publication
(10) Pub. No.: US 2010/0175082 A1
(43) Pub. Date: Jul. 8, 2010

(54) SYSTEM AND METHOD FOR INSERTING SPONSOR INFORMATION INTO CLOSED CAPTION CONTENT OF A VIDEO SIGNAL

(75) Inventors: Steven G. Blumenschein, Laurel, MD (US); Joseph E. Van Riper, III, Germantown, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: XOrbit, Inc., Columbia, MD (US)

(21) Appl. No.: 12/651,862

(22) Filed: Jan. 4, 2010

Related U.S. Application Data
(60) Provisional application No. 61/142,258, filed on Jan. 2, 2009.

(51) Int. Cl. H04N 7/025; H04N 7/00; G06F 17/30

(52) U.S. Cl. 725/32; 348/468; 707/602; 348/E07.001; 707/769; 707/E17.005; 707/E17.014

(57) ABSTRACT

Disclosed is a system and method of combining traditional programming caption data with advertising caption data in a single closed caption data stream. Advertising caption data is received from a data warehouse. When such advertising caption data is encoded into the closed caption data stream, it must temporally displace the traditional programming caption data that would otherwise be displayed. Thus, such programming caption data is buffered during display of the advertising caption data, and then is played out in an intelligent yet accelerated manner to maintain readability and recover the time lost during the sponsorship event.

### CROSS REFERENCE TO RELATED APPLICATION

This application is based upon and claims benefit of copending U.S. Provisional Patent Application Ser. No. 61/142,258 entitled “System And Method For Inserting Sponsor Information Into Closed Caption Content Of A Video Signal”, filed with the U.S. Patent and Trademark Office on Jan. 2, 2009 by the inventors herein, the specification of which is incorporated herein by reference.

### FIELD OF THE INVENTION

This invention relates generally to processing of closed caption data, and more particularly to systems and methods for inserting advertising or promotional content into a closed caption data transmission.

### BACKGROUND

Closed captioning is a system used to display text on a television or video screen, which text typically includes a transcription of the audio portion of a program as it is being viewed. Closed captioning may thus be used by persons with hearing impairments to allow them to better enjoy and comprehend a program they are viewing.

For analog television transmission, the closed caption standard is EIA-608, and for digital television transmission, the closed caption standard is EIA-708B. In each case, closed caption data is created by transcribing the particular program's script, text, or other information, and is encoded into the video signal, which integrated signal is then transmitted to broadcasters for transmission to end users.

To fund the development and transmission of broadcast content, broadcasters typically utilize third party advertising, selling time to advertisers in exchange for integrating advertisements into the programming content that is to be broadcast. While the process by which such broadcast advertising is sold and integrated with a broadcast transmission is well developed, the closed caption content that accompanies a typical broadcast transmission itself offers a separate advertising medium; however, the integration of other, third party content, such as advertising or promotional information, into a closed caption signal presents technical challenges that have until now remained unsolved. For instance, the closed caption transcription of a particular broadcast transmission is typically displayed in time with the video transmission so that the transcription text matches the action on the screen. Integration of additional third party information, such as third party advertising or promotional information, into the closed caption information will interrupt this flow, ultimately causing the original transcription to lag behind the action on the screen. It would therefore be advantageous to provide a method and system by which third party advertising or promotional content, or other third party information, could be integrated into a closed caption transmission without inhibiting a viewer's ability to interpret the original closed caption content and relate it to the action that they are viewing on the screen.

### SUMMARY OF THE INVENTION

Disclosed is a computer implemented method and system that allows additional data, such as advertising or promotional information or other data, to be combined with programming caption data (i.e., a caption transcribing a particular broadcast program, regardless of source) and inserted within a closed caption data stream. The method and system described herein provide dynamic, variable closed caption data stream information wherein advertising, promotional, sponsorship and/or various other types of information different from the programming caption data may be combined and encoded with the programming caption data into a video signal and displayed along with the original programming caption data. Thus, the method and system described herein are capable of creating a closed caption data stream that is a blended data stream, containing both programming caption data and advertising caption data, which is transmitted to an encoding device for encoding within a video signal and eventual display on a video display device.

As mentioned above, the insertion of an advertising caption into a closed caption data stream (i.e., to accompany the original programming caption data) may result in a delay in the display of the programming caption information to a viewer. Therefore, it is advantageous to account for such delay by causing the display of the original programming caption information to catch up with the then-current action on the video display. Through the buffering of incoming programming caption data, the method and system described herein are capable of delaying the transmission of programming captions long enough to ensure that the advertising caption is displayed for its full, pre-determined duration. The method and system described herein also allow the display of the programming caption information to catch up to the action on the screen in a graduated manner, to when the programming caption information should be displayed, ensuring that the programming captions do not appear for a duration that is so short as to prevent the viewer from reading the programming caption information. Thus, the method and system described herein provide for the integration of advertising caption information with the original programming caption information in a single closed caption signal, and likewise the display of such mixed caption content while accounting for the delay caused by the insertion of such advertising caption data and ensuring sufficient display of both types of content to enable comprehension of both types of content by a viewer. In summary, the invention provides an intelligent and accelerated manner to maintain the readability of the programming caption information while recovering any time lost during display of advertising caption information.

### BRIEF DESCRIPTION OF THE DRAWINGS

The numerous advantages of the present invention may be better understood by those skilled in the art by reference to the accompanying figures in which:

FIG. 1 is a schematic view of a closed caption advertisement insertion management system in accordance with a preferred embodiment of the invention.

FIG. 2 is a flow diagram of a first aspect of a method of operating the system of FIG. 1.

FIG. 3 is a schematic view of a computer hardware system suitable for use in implementing the closed caption advertisement insertion management system of FIG. 1.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed is a computer software and/or hardware-based system and method for combining programming caption data with advertising caption data in a single closed caption data stream. The system and method allow for the display of such mixed content closed caption information while ensuring readability of both types of content despite the lost programming caption display time incurred during display of the advertising caption information. Such readability and thus comprehension of both types of content is maintained by inserting the advertising caption data into the closed caption data stream, determining an extent to which the display of the programming caption information will be delayed as a result of such advertising caption data insertion, and speeding up the display of the programming caption information that is displayed after the advertising caption information for a sufficient period so as to both catch up the programming caption information display with the then-current action on the video screen and maintain readability of the more quickly displayed programming caption information.

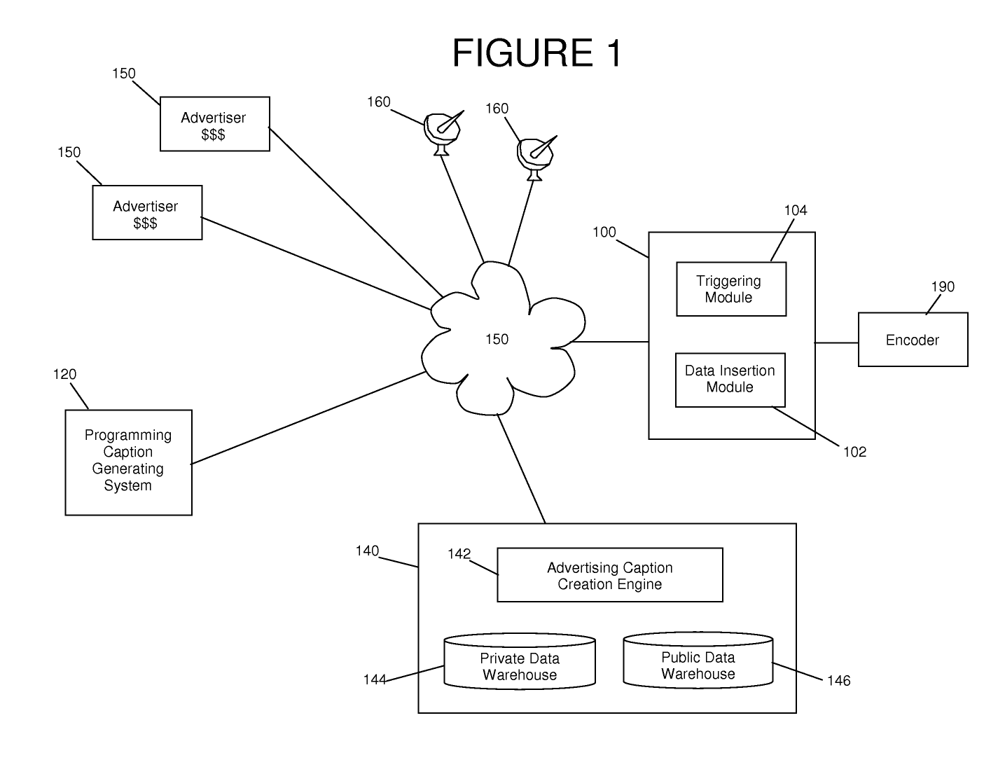

As shown in the schematic view of FIG. 1, in accordance with one aspect of a particularly preferred embodiment of the invention, a closed caption advertisement insertion management system 100 is configured to receive both programming caption data and advertising caption data from one or more various sources, manipulate such data streams to create a blended closed caption data stream including both advertising caption data and the originally intended programming caption data, and transmit such blended closed caption data stream to an encoder 190. As used herein, the term “advertising caption” is intended to refer to a caption that is not written particularly for the current program (i.e., is not part of a transcription of the program then being broadcast), and that preferably has an advertisement or promotional intent. The advertising caption is a unit of information, preferably either promotional or informational in nature, that is created and/or may be edited through use of a software application provided to a user, as will be discussed in greater detail below. The advertising caption may be a single item or a sequence of information that follows a defined data protocol, again as described in greater detail below.

Closed caption advertisement insertion management system 100 preferably includes a data insertion module 102 configured to, among other things, configure the blended closed caption data stream so as to allow the display of programming caption information that occurs after the display of advertising caption information to catch up to the live action then displayed in the video portion of the transmission. As will be discussed in greater detail below, a triggering module 104 is also provided that preferably determines at what point in the closed caption data stream data insertion module 102 may insert advertising captions for transmission to encoder 190, and particularly which advertising captions are suitable for insertion.

Closed caption advertisement insertion management system 100 may comprise a hosted application within, by way of non-limiting example, a server computer that is in communication with at least one programming content generating system 120, at least one advertising caption generating system 140, and encoder 190, and in which data insertion module 102 and triggering module 104 may comprise functions within such hosted application. Of course, other configurations, such as having each of data insertion module 102 and triggering module 104 comprise separate standalone applications or reside on separate computing devices, or having each of closed caption advertisement insertion management system 100, programming caption generating system 120, advertising caption generating system 140, and encoder 190 reside as separate applications on a single computing environment, will likewise be apparent to those of ordinary skill in the art and will not depart from the spirit and scope of the instant invention. However, in the exemplary environment depicted in FIG. 1, closed caption advertisement insertion management system 100 preferably communicates with programming caption generating system 120 and advertising caption generating system 140 across a computer network 110, such as a wide area network such as the Internet. The wide area computer network 110 preferably provides a delivery mechanism for delivering all types of data, such as audio, video, and/or other data, including metadata, to closed caption advertisement insertion management system 100. Those of ordinary skill in the art will nonetheless recognize that other delivery mechanisms may likewise be used for the delivery and/or receipt of data amongst the various systems and devices of the current invention, such as a local area network, an Intranet, a private telecommunication line, a “POTS” (plain old telephone system), or other electronic data communication mechanisms without departing from the spirit and scope of the invention. Likewise, the data exchanged among the various systems and devices of the current invention may include streaming video data, which may allow for either real-time or post production generation of caption data.

At least one programming caption generating system 120 communicates with closed caption advertisement insertion management system 100 so as to provide programming caption data associated with the particular broadcast transmission that is to be transcribed. The communication between such programming caption generating system 120 and closed caption advertisement insertion management system 100 preferably proceeds using TCP/IP packets. In this regard, and with particular reference to the exemplary embodiment depicted in FIG. 1, programming caption generating system 100 has an established connection to closed caption advertisement insertion management system 100 in a client/server relationship, and provides some information about programming caption generating system 120 to closed caption advertisement insertion management system 100. In particular, programming caption generating system 120 informs closed caption advertisement insertion management system 100 of what kind of data content the programming caption generating system 120 will send, such as (by way of non-limiting example) CC1, CC2, CC3, CC4, TT1, TT2, or so on. In a typical configuration, the programming caption generating system 120 may send only one particular kind of captioning information. While the current invention primarily envisages programming caption generating system 120 transmitting a single closed caption data stream, it is contemplated that the programming caption generating system 120 can be implemented for CC1, CC2, CC3, CC4, TT1, TT2, or so on, either as a single stream or simultaneously. In a similar manner it is contemplated that the advertising caption generating system 140 may communicate with the closed caption advertisement insertion management system 100, such that the advertising caption generating system transmission may include a single item or sequence of information that follows a defined data protocol and may come from one or multiple sources. Moreover, for each of the programming caption generating system 120 and advertising caption generating system 140, it is contemplated that other tunable feeds of captioning data, whether currently existing or yet to be implemented, may likewise be used, so long as they provide a discrete transmission channel, without departing from the invention.

The programming caption data can be created by one or more programming caption data generating systems 120 using any closed caption compliant creation system including a stenography device (e.g., a court reporter keyboard) or a voice recognition system, and a personal or network-enabled computing device. The closed caption output can then be transmitted over the communication network 110 described above to the closed caption advertisement insertion management system 100.

Output signals or data streams from disparate programming caption generating systems 120 travel independently to the closed caption advertisement insertion management system 100 where they are properly identified and blended with the advertising caption data into a single closed caption data stream that is transmitted to the encoding system 190. By way of example and without limitation, a method employed by the system of the current invention may include data insertion module 102 inserting advertising caption data into the closed caption data stream by writing advertising caption information to one or more insertion locations within closed caption advertisement insertion management system 100 (which may be an insertion encoder within the server and/or an insertion encoder connected to the system by serial, TCP/IP, or some other mechanism), and then inserting the advertising caption information into the closed caption data stream that will include the programming caption information, where the programming caption information has been and/or is being buffered within the closed caption advertisement insertion management system 100.

The closed caption advertisement insertion management system 100 may also provide for the segregation of multiple programming caption data streams. A lock (known as a mutex, for “mutually exclusive”) may be used by the system 100 to ensure two programming caption data streams cannot be inserted on top of each other. Regardless of the number of programming data streams received, the current invention allows the proper advertising caption data stream to be inserted into and associated with the proper programming caption data stream(s) of the correct closed caption data stream for transmission to an encoder 190. As will be described below, the current invention provides for the correct buffering of programming caption data streams and insertion of advertising caption data with particular programming caption data streams. This capability may be based on various technological solutions, such as encoder commands embedded by the system and/or encoded data transcoded by the system.

As mentioned above, advertising caption information is likewise created by an advertising caption generating system 140 and transmitted over the communication network 110 described above to the closed caption advertisement insertion management system 100 for insertion into, along with programming caption information, a closed caption data stream. Preferably, an advertising caption unit may comprise a single item or sequence of information that follows a defined data protocol, such as (by way of non-limiting example):

CustomerID: 1234567

Title: XYZ Appliance Discounts

ActivationDate: 2007-11-25

DeactivationDate: 2008-12-31

Impressions: 12

Language: 1

Placement: CC1,CC4

PlaylistRestrictions: −H53212,+H213443,+33923G,

Demographics: FOOD, HOMEIMPROVEMENT, BLACK, CAUCASION, FEMALE

CPMMIN: 25

CPMMAX: 50

Data: 00:00,0x14 0x2c 0x11 0x50 0x11 0x48 [Captioning Sponsored By Lowe's] 0x11 0x70 0x11 0x64 [Improving Home Improvement]

02:15,0x14 0x2c 0x11 0x50 0x11 0x40 [Visit Lowes.com today] 0x11 0x70 0x11 0x60 [for dishwasher discounts.]

The advertising caption unit may also include various other types of information along with its advertisement/promotional content, such as advertising caption playback management data including the number of insertions to be made, the expiration date for making the insertions or for the advertisement/promotional content, demographic information, and/or related business information for billing and affidavit purposes. Groups of advertising content units can be subsequently arranged for playback by these criteria. Such other types of information may be used by the method and system described herein in a number of beneficial ways. For instance, demographic information might be used to determine which language version of a particular advertisement should be included with a particular closed caption data stream (so as to avoid, for instance, a Russian language advertisement being included in a Spanish language closed caption data stream). Likewise, demographic data could be used to have only audience specific advertising caption data presented, such as advertisements for hardware retailers included in programs typically having do-it-yourself homeowners as the audience.

The source of the advertising caption data and, thusly, the promotional information, may be varied. For example, a company/advertiser 150 that is sponsoring the closed caption data stream that includes programming caption data for a particular broadcast may provide their sponsorship information (e.g., trademark or service mark) for storage in advertising caption generating system 140, which sponsorship information may then be accessed by the system and methods of the current invention. It is also contemplated that the system of the current invention, and particularly advertising caption creation engine 142, may assist in the creation, development and storage of advertising caption data content which may be accessed by the closed caption advertisement insertion management system 100 and manipulated by data insertion module 102 and then inserted into the outputted closed caption data stream for encoding and display within a video signal. Other sources of advertising caption units, as contemplated by those of ordinary skill in the art, may be employed without departing from the scope and spirit of the present invention.

Each advertising caption unit and/or the advertising caption playback management data can be recorded and stored in one or more data warehouses, such as private data warehouse 144 or public data warehouse 146 of advertising caption generating system 140, for use immediately or at a future time. Storage of the various advertising caption units and associated advertising caption playback management data in advertising caption generating system 140 may be variously configured, as may access to such data. In an exemplary embodiment, the advertising caption unit and playback management data may be stored in the advertising caption generating system 140 for later random access by the system of the current invention. In a preferred embodiment, the advertising caption generating system 140 includes a data warehousing/storage system. Thus, the current invention allows the closed caption advertisement insertion management system 100 to communicate with one or more data warehousing/storage systems associated with advertising caption generating system 140 to retrieve previously created advertising caption units. Likewise, the advertising caption creation engine 142 of advertising caption generating system 140 may facilitate the creation of advertising caption units which may then be stored in one or more data warehouses associated with advertising caption generation system 140.

Private data warehouse 144 and public data warehouse 146 may have varying access restrictions applied to them. For instance, the advertising caption unit and/or the advertising caption playback management data may be stored in private data warehouse 144 that may only be accessed by the system of the current invention. Alternatively, the advertising caption unit and/or advertising caption playback management data may be stored in public data warehouse 146 where the information is available only to authorized and/or authenticated users that are granted access. Potential authenticated advertisers 150 can submit advertising caption requests into the central public data warehouse 146, and broadcasters 160 with authentication credentials can access a desired advertising caption unit and add it to their internal private data warehouse 144 for playback. Thus, broadcasters 160 may be allowed to create and sell their own advertising caption units in addition to accessing a central public database 146 of interested advertisers. The technology used to prevent unauthorized access to the information stored in such data warehouses may be any type of restricted access technology that are known and used by those of ordinary skill in the art.

The advertising caption and/or programming caption data may be formatted in accordance with various data protocols. By way of non-limiting example, the data may be formatted under the EIA-608 standard (incorporated herein by reference) which describes how captioning is to be formatted for the various stream types. Such information may be found in EIA-608 5.4 (Closed Caption Mode), 5.5 (Text Mode), 8.18 (Data Channel Nomenclature for Captions and Text), and Annex D (Closed Captioning Codes). In the alternative the data may be formatted under the EIA-708 standard. Those of ordinary skill in the art will recognize that other standards and/or encoding schemes may be employed, including those yet to be implemented for digital video, without departing from the scope and spirit of the instant invention.

Data insertion module 102 of closed caption advertisement insertion management system 100 may operate in either manual or automatic modes, depending upon the configuration by the user. The encoding process, however, is the same in both methods.

The automatic process requires an intelligent system to determine which advertising caption should be inserted into the system at the right time, by querying a data warehouse, such as private data warehouse 144 described above, for advertising caption playback management data that determine an opportunity window by date, time or other content identifiers. The system is able to monitor an existing advertising caption playlist provided by a third-party system and/or the outgoing content itself to make such determinations. By way of example and without intending to limit the scope of the current invention, UltraCast™ (which is readily commercially available from XOrbit, Inc.) may use automation playlist knowledge to determine the insertion point. Additionally, UltraCast™ can provide this service for events that are not captioned by UltraCast™ because it can capture the upstream data and add it to the buffer for reinsertion. Other automation systems that are readily commercially available may be obtained to provide playlist data that is used to determine insertion points, and such devices may typically communicate on serial (RS232 or RS422) and IP.

A manual process engages triggering module 104 of closed caption advertisement insertion management 100 to determine when advertising captions may be inserted into the video signal. Triggering module 104 is responsible for providing the user an opportunity to select the appropriate advertising caption for transmission by communicating with a data warehousing system. Communication between the data warehouse and the data insertion module 102 can be accomplished via private or public network protocols, direct connection or other supported data transfer process (e.g., RTX®, which is readily commercially available from XOrbit, Inc., may use a “Block Upstream” encoder command to determine the insertion point).

Once a determination is made, either manually or automatically, the system loads the advertising caption into memory and begins to convert the data to the appropriate format for insertion into the video encoding device 190. The data is transmitted to the encoding device 190 using the appropriate data protocol, over serial, IP or other required methodology. Further, it is contemplated that the data stream may be transmitted over various discrete transmission channels, whether now existing or developed in the future. It is contemplated that the encoding hardware and/or software, such as caption encoder 190, may be obtained from commercial vendors, which devices typically communicate on serial (RS232 or RS422) or IP. The signal(s) that are encoded with the novel closed caption data stream provided by the current invention are video signals and may be formatted in various manners, such as Standard Definition (SD), High Definition (HD) or other formatting schemes as may be employed by those of ordinary skill in the art.

While the advertising caption is loaded into memory and being converted to the appropriate format for insertion, other programming caption data may be available for the signal as well. Programming caption data may be buffered through a process that accumulates the existing/incoming programming caption data and then plays it out in an intelligent, yet accelerated manner to maintain readability and recover the time lost during display of the advertising caption information. Thus, after the buffered programming caption data is inserted back into the closed caption data stream for encoding into a video signal, normal data flow resumes. At the completion of the display of the advertising caption, the system may be set to update the private data warehouse 144 and/or the public data warehouse 146 indicating that it has played the event successfully.

A method of the current invention accounts for and delays the display of programming caption data to accommodate the display of advertising caption data within a closed caption data stream and also accomplishes the graduated/accelerated playback of the programming caption data. As used in the following discussion, the following terms have the meanings indicated: Advertised Caption Duration (ACD): the length of time an advertising caption is displayed. Advertised Caption Time (ACT): the time at which an advertising caption is displayed. Programming Caption Delay (PCD): the amount of delay applied to a programming caption before display.

First Programming Caption Time (FPCT): the point in time when the first programming caption arrived to the system after an advertising caption is displayed.

Programming Caption Time (PCT): the point of time when a programming caption arrived to the system.

Delay Duration (DD): the amount of time during which we decrement the PCD, until the PCD reaches zero, starting from the FPCT.

Decrement Amount (DA): the amount of time subtracted from the PCD over the course of the DD.

The method includes a first step wherein all delay values are converted to milliseconds. Then the programming caption delay (“PCD”) is determined as follows:

PCD/DA=x

where x is the number of times that the DA may be subtracted from the PCD, until a zero value is reached. This value must be distributed across the DD evenly, which is represented by the formula:

DD/x=y

where y is the number of milliseconds between the times we reduce the PCD by the DA. Then the following calculation determines the number of times that the DA must be subtracted from the DD:

(PCT−FPCT)/y=z

Then the number of milliseconds to subtract from the PCD is determined by using the following formula:

z*DA=f

f can also be written in expanded notation as follows:

f=((PCT−FPCT)/(DD/(PCD/DA)))*DA

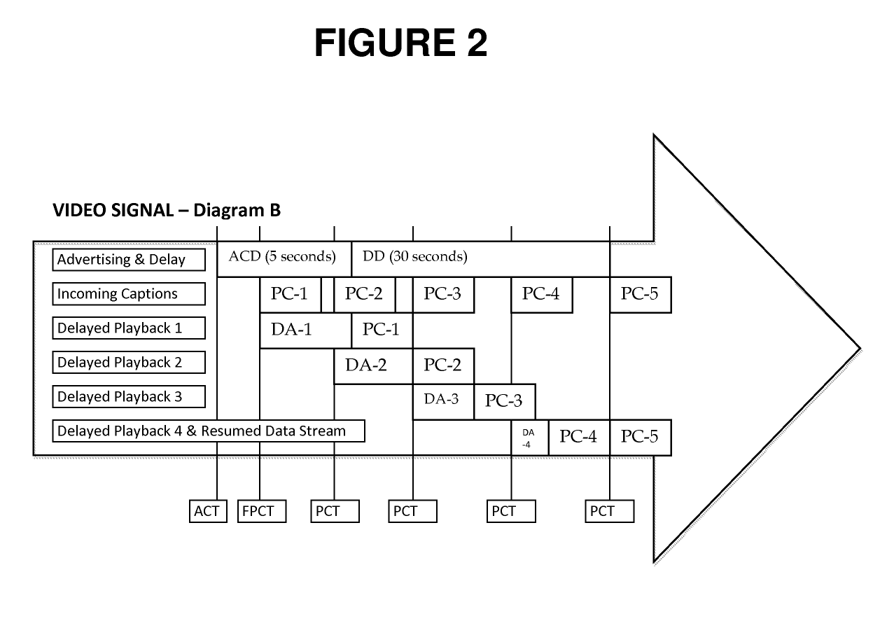

FIG. 2 provides a graphical representation of the implementation of such a delay. The advertising caption display (ACD) may, for example, last approximately 5 seconds and the total delay duration (DD) may be an additional 30 seconds. During the display of the advertising caption unit data insertion module 102 receives PC-1 (i.e., “programming caption 1”) and begins the receipt of PC-2. PC-3 and PC-4 are also received by data insertion module 102 during the DD period of time. Thus, in the exemplary depiction of FIG. 2, in total the data insertion module 102 will have to accommodate the receipt, delay and graduated display of four programming caption data streams. The data insertion module 102 accomplishes this using the method outlined above, where (as shown in FIG. 2) PC-1 is given a delayed playback 1 (DA-1). As shown, the DA-1 results in PC-1 being displayed upon the conclusion of the display of the advertising caption unit. PC-2 is given a delayed playback 2 (DA-2), which results in PC-2 being displayed upon the conclusion of the delayed display of PC-1. PC-3 is given a delayed playback 3 (DA-3), which results in PC-3 being displayed upon the conclusion of the delayed display of PC-2. PC-4 is given a delayed playback 4 (DA-4), which results in PC-4 being displayed upon the conclusion of the delayed display of PC-3. The playback of PC-1, PC-2, PC-3, and PC-4 have thus occurred within the DD of 30 seconds, and this has allowed normal playback of the programming caption data stream to resume as is indicated by the display of PC-5. Thus, the data insertion module 102 receives, buffers, and provides for the graduated playback of the programming caption data streams upon the conclusion of the display of the advertising caption and allows normal playback to resume of the programming caption data streams.

The above method of the current invention allows the programming captions to be delayed long enough such that the advertising caption is displayed for its full, pre-determined duration, while any incoming programming caption data is buffered. Then, the system will cause the programming captions to catch up in a graduated fashion, to when they should be displayed, ensuring that they do not appear for a duration that is so short as to prevent the viewer from reading the caption.

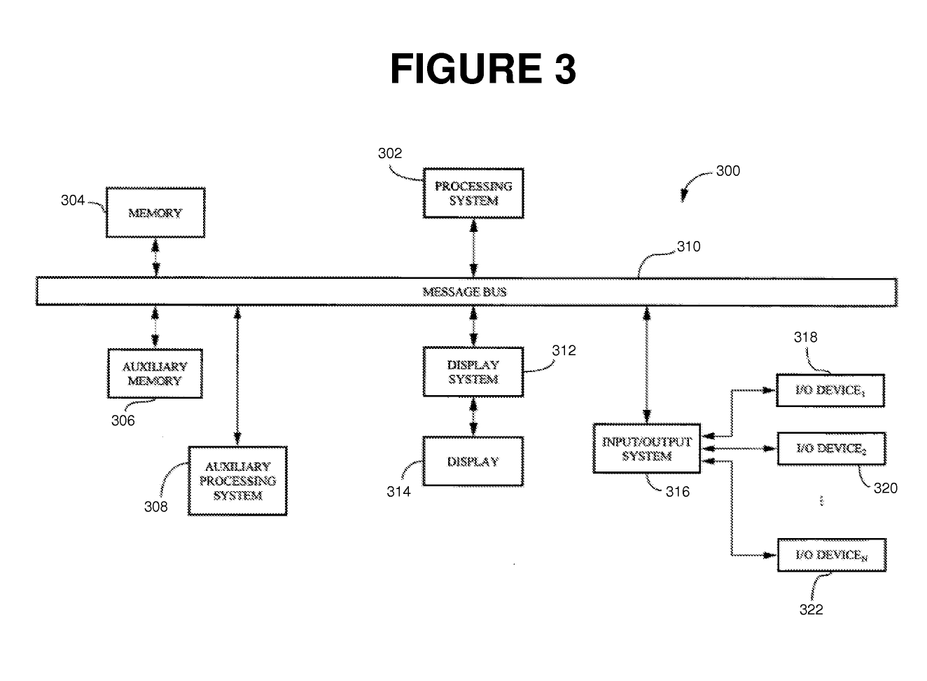

Closed caption advertisement insertion management system 100 may be hosted on a server computer configured to communicate with client devices hosting programming caption generating systems 120 and advertising caption generating systems 140 in a client/server application relationship communicating with one another using TCP/IP packets. An exemplary hardware system generally representative of a computing device suitable for use as such server and client devices is shown in FIG. 3. In each case, a central processing system 302 controls the hardware system 300 for each of the closed caption advertisement insertion management system 100 and the clients hosting programming caption data generating systems 120 and advertising caption generating systems 140. A central processing unit such as a microprocessor or microcontroller for executing programs is included in the central processing system 302 for the performance of data manipulations and controlling the tasks of the hardware system 300. A system bus 310 provides the communication with the central processor 302 for transferring information among the components of the hardware system 300. Facilitating information transfer between storage and other peripheral components of the hardware system may be a data channel that may be included in bus 310. Further, the set of signals required for communication with the central processing system 302 including a data bus, address bus, and control bus is provided by bus 310. It is contemplated that any state of the art bus architecture according to promulgated standards may be utilized for bus 310, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

A main memory 304 and auxiliary memory 306 (including an auxiliary processing system 308, as required) may be provided. The storage of instructions and data for programs executing on the central processing system 302 is provided by main memory 304. Typically semiconductor-based memory such as dynamic random access memory (DRAM) and/or static random access memory (SRAM) is used for the main memory 304. However, main memory 304 may utilize other semi-conductor-based memory types, such as synchronous dynamic random access memory (SDRAM), Rambus dynamic random access memory (RDRAM), ferroelectric random access memory (FRAM), and so on. The storage of instructions and data that are loaded into the main memory 304 before execution is provided by auxiliary memory 306. The storage capabilities provided by the auxiliary memory 306 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). Alternatively, a variety of non-semiconductor-based memories, including but not limited to floppy disk, hard disk, magnetic tape, drum, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and other varieties of memory devices as contemplated may be used for auxiliary memory 306.

Auxiliary processors of the auxiliary processing system 308, which are discrete or built into the main processor, may be included in hardware system 300. These auxiliary processors may be used as a digital signal processor (a special-purpose microprocessor having an architecture suitable for fast execution of signal processing algorithms), as a back-end processor (a slave processor subordinate to the main processing system), as an additional microprocessor or controller for dual or multiple processor systems, or as a coprocessor. They may also be used to manage input/output and/or to perform floating point mathematical operations.

A display system 312 for connecting to a display device 314, wherein the display system 312 may comprise a video display adapter having all of the components for driving the display device, including video memory, buffer, and graphics engine as desired, is included in hardware system 300. Video memory may be, for example, windows random access memory (WRAM), video random access memory (VRAM), synchronous graphics random access memory (SGRAM), and the like. The display device 314 may comprise a cathode ray-tube (CRT) type display such as a monitor or television, or an alternative type of display technology such as a projection-type CRT display, a light-emitting diode (LED) display, a gas or plasma display, an electroluminescent display, a vacuum fluorescent display, a cathodoluminescent (field emission) display, a liquid-crystal display (LCD) overhead projector display, an LCD display, a plasma-addressed liquid crystal (PALC) display, a high gain emissive display (HGED), and so forth.

An input/output (I/O) system 316 for connecting to one or more I/O devices 318, 320, and up to N number of I/O devices 322 is included in hardware system 300. Interface functions between the one or more I/O devices 318-322 may be provided by various controllers or adapters. I/O devices such as a keyboard, mouse, trackball, touchpad, joystick, trackstick, infrared transducers, printer, modem, RF modem, bar code reader, charge-coupled device (CCD) reader, scanner, compact disc read-only memory (CD-ROM), digital versatile disc (DVD), video capture device, touch screen, stylus, electroacoustic transducer, microphone, speaker, and others may be communicatively coupled by various interface mechanisms, such as universal serial bus (USB) port, universal asynchronous receiver-transmitter (UART) port, serial port, IEEE 1394 serial bus port, infrared port, network adapter, parallel port, printer adapter, radio-frequency (RF) communications adapter, and others. Analog or digital communication capabilities between the hardware system 300 and the input/output system 316 and I/O devices 318-322 may be provided for communication with external devices, networks, or information sources. Preferably industry promulgated architecture standards are implemented by system 316 and I/O devices 318-322, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It is to be understood that modification or reconfiguration of the hardware system 300 of FIG. 3 by one having ordinary skill in the art would not depart from the scope or the spirit of the present invention.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

I claim:

1. A computer implemented method for inserting sponsorship information into a closed caption data stream, comprising the steps of:
receiving programming caption data comprising a transcription of an audio portion of a program intended for broadcast with said programming caption data and for display to a viewer as such audio portion of said program occurs;
receiving advertising caption data comprising promotional information that is not a transcription of said program; and
combining said programming caption data and said advertising caption data in a single closed caption data stream such that upon playback of said closed caption signal, display of at least a portion of said programming caption data is delayed by an amount sufficient to allow viewing of said advertising caption data, and said portion of said programming caption data is subsequently displayed to a viewer for a shortened duration until subsequent programming caption data is displayed in time with an associated audio portion of said program.

2. The computer implemented method of claim 1, further comprising the steps of:
determining a delay amount by which display of said portion of said programming caption data is to be delayed prior to display to a viewer.

3. The computer implemented method of claim 2, wherein said combining step further comprises encoding a delay equal to said delay amount in said closed caption data stream so as to delay playback of said portion of said programming caption data by said delay amount.

4. The computer implemented method of claim 1, further comprising the steps of:
providing a data warehouse storing a plurality of units of said advertising caption data; and
electronically marking a unit of said advertising caption data as having been displayed to a user after said unit of said advertising caption data has been combined with programming caption data.

5. The computer implemented method of claim 1, wherein said advertising caption data further comprises playback management data, the method further comprising the steps of:
providing a data warehouse storing a plurality of units of said advertising caption data; and
querying said playback management data of a plurality of units of advertising caption data to determine a suitable unit of said advertising caption data for combining with said programming caption data.

6. The computer implemented method of claim 5, wherein said playback management data used to determine a suitable unit of said advertising caption data for combining with said programming caption data is selected from the group consisting of: (i) number of allowable insertions of a unit of advertising caption data; (ii) expiration date of a unit of advertising caption data; and (iii) demographics of intended viewers of a unit of advertising caption data.

7. A system for inserting sponsorship information into a closed caption data stream, comprising:
a closed caption advertisement insertion management system computer having executable computer code stored thereon adapted to:
receive programming caption data comprising a transcription of an audio portion of a program intended for broadcast with said programming caption data and for display to a viewer as such audio portion of said program occurs;
receive advertising caption data comprising promotional information that is not a transcription of said program; and
combine said programming caption data and said advertising caption data in a single closed caption data stream such that upon playback of said closed caption signal, display of at least a portion of said programming caption data is delayed by an amount sufficient to allow viewing of said advertising caption data, and said portion of said programming caption data is subsequently displayed to a viewer for a shortened duration until subsequent programming caption data is displayed in time with an associated audio portion of said program.

8. The system of claim 7, said executable computer code being further adapted to:
determine a delay amount by which display of said portion of said programming caption data is to be delayed prior to display to a viewer.

9. The system of claim 8, said executable computer code being further adapted to:
encode a delay equal to said delay amount in said closed caption data stream so as to delay playback of said portion of said programming caption data by said delay amount.

10. The system of claim 7, further comprising a data warehouse in communication with said closed caption advertisement insertion management system computer, said data warehouse storing a plurality of units of said advertising caption data, said executable computer code being further adapted to:
electronically mark a unit of said advertising caption data as having been displayed to a user after said unit of said advertising caption data has been combined with programming caption data.

11. The system of claim 7, further comprising a data warehouse in communication with said closed caption advertisement insertion management system computer, said data warehouse storing a plurality of units of said advertising caption data and said advertising caption data further comprising playback management data, said executable computer code being further adapted to:
query playback management data of a plurality of units of advertising caption data to determine a suitable unit of said advertising caption data for combining with said programming caption data.

12. The system of claim 11, wherein said playback management data used to determine a suitable unit of said advertising caption data for combining with said programming caption data is selected from the group consisting of: (i) number of allowable insertions of a unit of advertising caption data; (ii) expiration date of a unit of advertising caption data; and (iii) demographics of intended viewers of a unit of advertising caption data.
